(19) United States
(12) Patent Application Publication
(10) Pub. No.: US 2006/0107228 A1
(43) Pub. Date: May 18, 2006

(54) METHOD FOR CREATING DATA FILES

(75) Inventors: Bryan Holzbauer, Gardnerville, NV (US); Scott Williams, Minden, NV (US); James A. Maxson, Minden, NV (US); Shane Jenkins, Minden, NV (US); Richard Gomer, Carson City, NV (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/904,492

(22) Filed: Nov. 12, 2004

(51) Int. Cl. G06F 9/00

(52) U.S. Cl. 715/780; 715/968

(57) ABSTRACT

A method, system, and article of manufacture such as software media is disclosed for creating a text input file and a text output file according to the requirements of a power generation party.

### CROSS REFERENCE TO RELATED APPLICATION

This application incorporates by reference the entire disclosures of two related applications entitled: CREATION OF FUTURE TIME INTERVAL POWER GENERATION DATA USING HISTORICAL DATA and CREATION AND CORRECTION OF FUTURE TIME INTERVAL POWER GENERATION CURVES FOR POWER GENERATION COSTING AND PRICING, respectively, which were filed concurrently herewith.

### BACKGROUND OF THE INVENTION

The power generation industry has been increasingly opened to free market competition. As part of this new regulatory environment, Independent Systems Operators (ISOs) groups, which are one example of a power generation party, have emerged. ISO's can be thought of as regional areas containing individual power producers. Although rules may vary in a specific ISO environment, for background purposes it is fair to say that, as part of planning for daily operation, a bidding process occurs wherein power producers submit estimates and bids to provide power in a region for the next day. These estimates typically state the cost to generate power for the next day, and also state the seller's asking price for the next day. From these bids, a seller(s) within the ISO group is selected to supply power to a region for the next day. Therefore, success in the bidding process is critical to the success of a seller.

### BRIEF DESCRIPTION OF THE INVENTION

A method, system, and article of manufacture such as software media is disclosed for creating a text output file and a text input file according to the requirements of a power generation party. This may comprise creating an input file specifying static text and key identifiers arranged in an arrangement according to text format requirements of a power generation party. Processing the input file through a management application comprising searching for variables from the management application where the searching is performed according to the key identifiers which correspond to the variables from the management application and outputting a text output file corresponding to the text format requirements of the power generation party where the text output file comprises copied versions of the static text and also retrieved text found in the variables which correspond to the key identifiers and wherein the static text and the retrieved text is output in the text output file according to the arrangement of the key identifiers in the input file.

### BRIEF DESCRIPTION OF THE DRAWINGS

The following description of the figures is not intended to be, and should not be interpreted to be, limiting in any way.

FIG. 1 is a diagram of an example of a power generation party environment.

FIG. 2 is an example of a text input file in accordance with an embodiment.

FIG. 3 is an example of a text output file in accordance with an embodiment.

FIG. 4 is a flow chart showing a process of an embodiment.

### DETAILED DESCRIPTION OF THE INVENTION

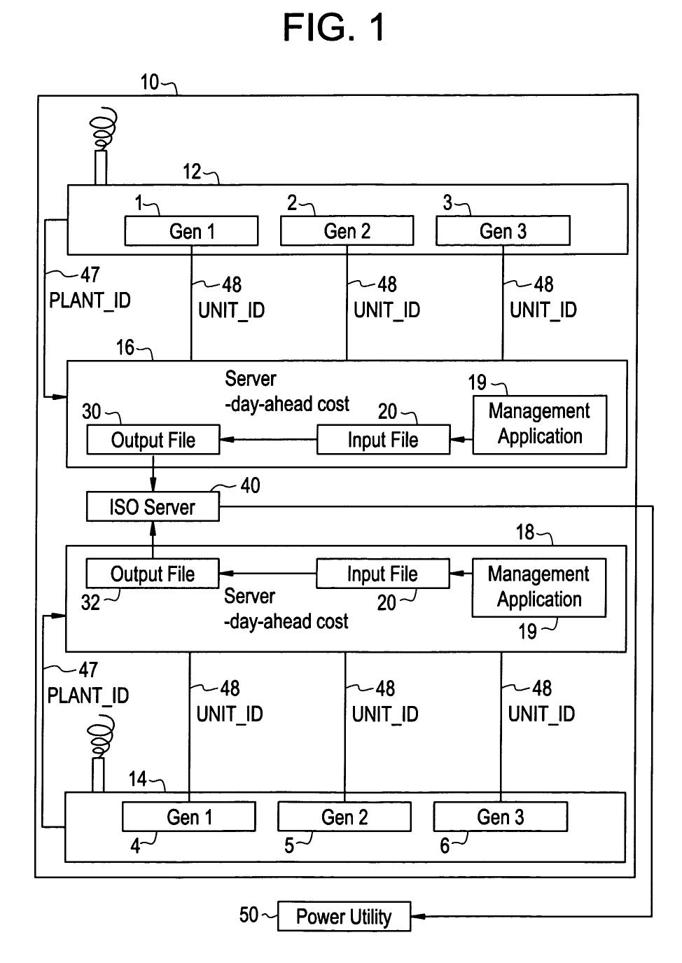

Referring to FIG. 1, an Independent Systems Operators (ISO) group or environment is shown. An ISO 10 is one example of a power generation party and many other configurations of a power generation party are possible. Thus, the disclosure herein is applicable and may be configured to work with any power generation party. For example, every power generation party may have its own policies and procedures.

An ISO 10 covers a region. Thus, in the example region of ISO 10, it can be seen that two power generating plants (12, 14) are shown in this example of an ISO 10. Typically there are many generating plants in an ISO 10, so this example is not intended to be limiting.

In reference to FIGS. 1-4 an exemplary embodiment is described. Each power generating plant (12, 14) has any number of generating units, for example GEN 1-GEN3 (1,2,3) in power generating plant 12. For power generating plant 14, the generating units (1,2,3) are linked to a server 16. This server 16 runs a management application 19. The management application 19 receives and/or computes data regarding the generating units (1,2,3) which can than be used to create a bid (not shown) to sell power for the day ahead. In this example, according to the policy rules of the ISO 10, the bid from power plant 12 would be sent to ISO server 40. ISO server 40 is the location where all of the bids are stored including bids from other power plants in the ISO 10. The best bid is selected and then Power Utility 50 (the buyer) is supplied with the power on the next day.

However, each power generation party which in this example is ISO 10 has its own particular rules. For example each ISO 10 may require that the bids be submitted as text files and they may specify a specific format for example a text format such as XML, CSV, and flat text and/or other file formats. Thus, the formats for the files are specified by each ISO, and the formats are typically different for every ISO. Modifying the management application 19 software is not practical because all or many of the power generating plants may buy the same management application 19 to run in different ISO's.

Therefore, an interface termed an Input file 20 is provided herein which can be processed by the management application 19 to produce output files 30 that can be read by a specific ISO 10 according to the ISO's format requirements. However, the Input file 20 can be processed by the management application 19 without modifying the management application 19. In this manner, data in server 16 for example will be output in an output file 30 which conforms to the ISO's 10 text file format requirements without modifying the management application 19. This method may be implemented in software for example.

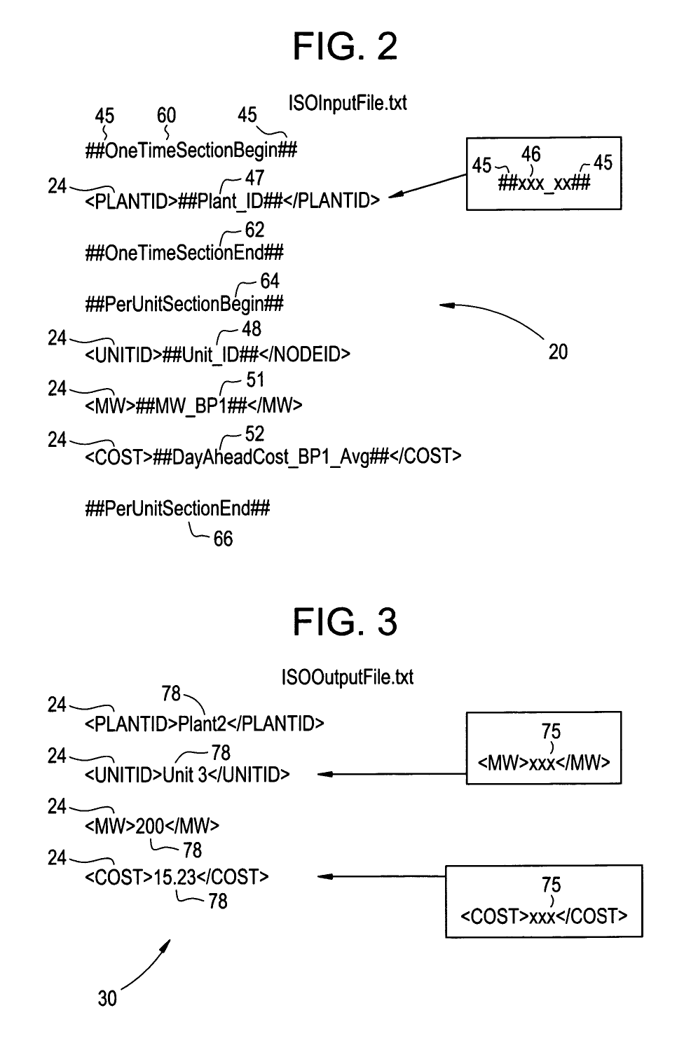

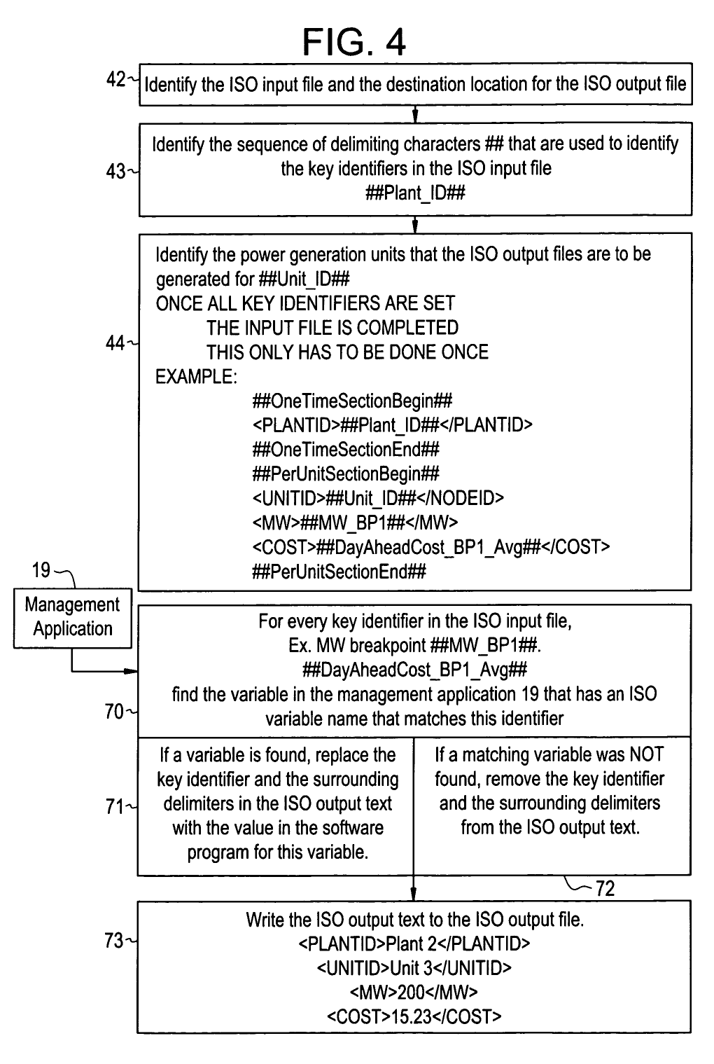

In FIG. 2 an example of one embodiment of Input file 20 is shown and in FIG. 3 an example of Output file 30 is shown. How the Input file 20 is configured in order to form Output file 30 is formed is shown at 42-44 in FIG. 4.

In FIG. 4, processes 42-44 comprise configuring the input file 20 in this example. A user who is familiar with the ISO 10 requirements will configure the input file 20. Once the input file 20 is configured for the ISO 10 requirements, it can be used every day to generate bids in the ISO 10. Thus advantageously, configuration of the input file 20 may typically occur once. At 42, the ISO input file 20 is identified and the destination location for the ISO output file 30 is specified. At 43, a sequence of delimiting characters 45 such as two pound signs “##” are identified and are used to identify the key identifiers 46 such as Plant_ID 47 in the ISO input file, i.e., ##Plant_ID##. The number of key identifiers 46 will depend on the requirements of the ISO 10. Another key identifier in this example is Unit_ID 48. At 44, the power generation units (1,2,3) that the output files 30 are to be generated for, i.e., ##Unit_ID## 48 are configured. Additional examples of key identifiers 46 are for example, megawatt break point, i.e., MW breakpoint ##MW_BP1 ## 52 and ##DayAheadCost_BP1_Avg## 53 which is a forecasted cost of the power to be sold on the day ahead at a megawatt level in this example.

Also, included in this example of the input file 20 are reserved tag names 49 which in this example control loops. For example, OneTimeSectionBegin tag 60 begins a loop to identify the Plant_ID 47. OneTimeSectionEnd tag 62 stops the loop.

Once all the key identifiers are arranged the input file 20 is configured in a format consistent with the ISO 10 (which is a power generation party) requirements and is ready to run with the management application 19. See the example of configured input file 20 at 44 and in FIG. 2.

Thus, in summary, the input file 20 is a manually created, text-based file that defines how the output file(s) 30 are to be created. The arrangement and text format of the Input file 20 is determined based on the file format specifications defined by the policies of the ISO 10. The Input file 20 will include static text 24 that gets copied directly to the output file 30 and key identifiers 46 that either get removed or replaced by text 78 from variables 75 provided via the management application 19 which may be an associated software program. The key identifiers 46 in the Input file(s) 20 are identified using a tag name surrounded on both sides with a configurable set of delimiting characters 45. There is an option available to define sections in these files that are to be processed either one time or on a per-unit basis. To handle these scenarios, there are special reserved tag names 49 that can be used in the input file 20 to identify the bounds of these two types of sections.

Next, the operation of the Input File 20 is discussed at reference numerals 70-73 in FIG. 4. For example in this embodiment, the management application 19 stores or has access to data regarding the generating units (1,2,3) in variables 75. The variables 75 have names that correspond to the key identifiers 46. Thus as shown at 70 in FIG. 4, for every key identifier 46 in Input file 20, for example, MW breakpoint ##MW_BP1 ## 51 and ## DayAheadCost_BP1_Avg## 52, the management application 19 finds the variable 75 that has a variable 75 name that matches the key identifiers 46. At 71 it is shown that if a variable 75 is found, the management application 19 replaces the key identifier 46 and the surrounding delimiting characters 45 in the output file 20 text with a value for the variable 75 from the management application 19 for the variable 75. Alternatively, at 72 it is shown that if a matching variable 75 was not found, for the key identifier 46, the key identifier 46 and the surrounding delimiting characters 45 are removed from found text to be written to the output file 30. These steps are repeated until all of the key identifiers 46 have been found or replaced. Then at 73, the output file 30 is created by writing the static text 24 and found text 78 from the variables 75 to the output file 30 as shown in FIG. 4, for example. Thus, the output file 30 follows the arrangement or order of the input file regarding the key identifiers 46. As can be seen by comparing FIG. 2 to FIG. 3, the other parts of the input file 20 such as the reserved tag names 49 like ##OneTimeSectionBegin## are not written to the Output file 30. Thus, an Output file in desired form or format is outputted.

Thus, an output file 30 is created which can be read according to the ISO 1 0's requirements but without modifying the management application 19. This output file 30 can be used to generate a bid that is sent to the ISO server for example.

Of course, other configurations of the Input file 20 are possible depending upon the ISO 10 or power generation party. Also, other key identifiers 46, delimiting characters 45, reserved tag names 49 may be used and are within the scope of this disclosure.

It is also noted that FIG. 1 illustrates an example of a suitable computing system environment in which the methods and apparatus described above and/or claimed herein may be implemented. The computing system environment is only one example of a suitable computing environment and is not intended to suggest any limitation as to the scope of use or functionality of the invention. Neither should the computing environment shown in FIG. 1 be interpreted as having any dependency or requirement relating to any one or combination of components illustrated in the exemplary operating environment in FIG. 1.

One of ordinary skill in the art can appreciate that a computer or other client or server device can be deployed as part of a computer network, or in a distributed computing environment. In this regard, the methods and apparatus described above and/or claimed herein pertain to any computer system having any number of memory or storage units, and any number of applications and processes occurring across any number of storage units or volumes, which may be used in connection with the methods and apparatus described above and/or claimed herein. Thus, the same may apply to an environment with server computers and client computers deployed in a network environment or distributed computing environment, having remote or local storage. The methods and apparatus described above and/or claimed herein may also be applied to standalone computing devices, having programming language functionality, interpretation and execution capabilities for generating, receiving and transmitting information in connection with remote or local services.

The methods and apparatus described above and/or claimed herein is operational with numerous other general purpose or special purpose computing system environments or configurations. Examples of well known computing systems, environments, and/or configurations that may be suitable for use with the methods and apparatus described above and/or claimed herein include, but are not limited to, personal computers, server computers, hand-held or laptop devices, multiprocessor systems, microprocessor-based systems, network PCs, minicomputers, mainframe computers, distributed computing environments that include any of the above systems or devices.

The methods described above at FIGS. 2-4 for example, and/or claimed herein may be described in the general context of computer-executable instructions, such as program modules, being executed by a computer. Program modules typically include routines, programs, objects, components, data structures, etc. that perform particular tasks or implement particular abstract data types. Thus, the methods and apparatus described above and/or claimed herein may also be practiced in distributed computing environments such as between different power plants or different power generator units where tasks are performed by remote processing devices that are linked through a communications network or other data transmission medium. In a typical distributed computing environment, program modules and routines or data may be located in both local and remote computer storage media including memory storage devices. Distributed computing facilitates sharing of computer resources and services by direct exchange between computing devices and systems. These resources and services may include the exchange of information, cache storage, and disk storage for files. Distributed computing takes advantage of network connectivity, allowing clients to leverage their collective power to benefit the entire enterprise. In this regard, a variety of devices may have applications, objects or resources that may utilize the methods and apparatus described above and/or claimed herein.

Computer programs implementing the method described above will commonly be distributed to users on a distribution medium such as a CD-ROM. The program could be copied to a hard disk or a similar intermediate storage medium. When the programs are to be run, they will be loaded either from their distribution medium or their intermediate storage medium into the execution memory of the computer, thus configuring a computer to act in accordance with the methods and apparatus described above.

The term “computer-readable medium” encompasses all distribution and storage media, memory of a computer, and any other medium or device capable of storing for reading by a computer a computer program implementing the method described above.

Thus, the various techniques described herein may be implemented in connection with hardware or software or, where appropriate, with a combination of both. Thus, the methods and apparatus described above and/or claimed herein, or certain aspects or portions thereof, may take the form of program code or instructions embodied in tangible media, such as floppy diskettes, CD-ROMs, hard drives, or any other machine-readable storage medium, wherein, when the program code is loaded into and executed by a machine, such as a computer, the machine becomes an apparatus for practicing the methods and apparatus of described above and/or claimed herein. In the case of program code execution on programmable computers, the computing device will generally include a processor, a storage medium readable by the processor which may include volatile and non-volatile memory and/or storage elements, at least one input device, and at least one output device. One or more programs that may utilize the techniques of the methods and apparatus described above and/or claimed herein, e.g., through the use of a data processing, may be implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of described above and/or claimed herein may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or a receiving machine having the signal processing capabilities as described in exemplary embodiments above becomes an apparatus for practicing the method described above and/or claimed herein. When implemented on a general-purpose processor, the program code combines with the processor to provide a unique apparatus that operates to invoke the functionality of the methods and apparatus of described above and/or claimed herein. Further, any storage techniques used in connection with the methods and apparatus described above and/or claimed herein may invariably be a combination of hardware and software.

While the methods and apparatus described above and/or claimed herein are described above with reference to an exemplary embodiment, it will be understood by those skilled in the art that various changes may be made and equivalence may be substituted for elements thereof without departing from the scope of the methods and apparatus described above and/or claimed herein. In addition, many modifications may be made to the teachings of above to adapt to a particular situation without departing from the scope thereof. Therefore, it is intended that the methods and apparatus described above and/or claimed herein not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another. Furthermore, it should be emphasized that a variety of computer platforms, including handheld device operating systems and other application specific operating systems are contemplated, especially given the number of wireless networked devices in use.

What is claimed is:

1. A method for creating text output files from a management application comprising:
creating an input file specifying static text and key identifiers arranged in an arrangement according to text format requirements of a power generation party;
processing the input file through a management application comprising:
searching for variables from the management application where the searching is performed according to the key identifiers which correspond to the variables from the management application; and
outputting a text output file corresponding to the text format requirements of the power generation party where the text output file comprises copied versions of the static text and also retrieved text found in the variables which correspond to the key identifiers and wherein the static text and the retrieved text is output in the text output file according to the arrangement of the key identifiers in the input file.

2. The method of claim 1 wherein the processing of the input file to output the text output file further comprises:
generating the text output file wherein the text output file excludes delimiting characters associated with the key identifiers and reserved tag names.

3. The method of claim 1 wherein the power generation party is an Independent Systems Operators (ISO) group.

4. The method of claim 1 further comprising controlling at least one loop by including reserved tag names which control the loop during the processing of the input file to search for variables.

5. The method of claim 1 wherein at least one of the variables contains a future proposed cost of producing power.

6. The method of claim 1 further comprising sending the text output file to an ISO server.

7. One or more computer-readable media having computer-readable instructions thereon which, when executed by a computer, cause the computer to:
create an input file specifying static text and key identifiers arranged in an arrangement according to text format requirements of a power generation party;
process the input file through a management application comprising:
searching for variables from the management application where the searching is performed according to the key identifiers which correspond to the variables from the management application; and
outputting a text output file corresponding to the text format requirements of the power generation party where the text output file comprises copied versions of the static text and also retrieved text found in the variables which correspond to the key identifiers and wherein the static text and the retrieved text is output in the text output file according to the arrangement of the key identifiers in the input file.

8. The one or more computer-readable media of claim 7, which further cause the computer to:
generate the text output file wherein the text output file excludes delimiting characters associated with the key identifiers and reserved tag names.

9. The one or more computer-readable media of claim 7, wherein the power generation party is an Independent Systems Operators (ISO) group.

10. The one or more computer-readable media of claim 7, which further cause the computer to control at least one loop by including reserved tag names which control the loop during the processing of the input file to search for variables.

11. The one or more computer-readable media of claim 7, wherein at least one of the variables contains a future proposed cost of producing power.

12. The one or more computer-readable media of claim 7, which further cause the computer to send the text output file to an ISO server.

13. A system for outputting text output files with text data from a management application for a power generation party comprising: means for retrieving text data via a management application according to key identifiers arranged in an arrangement corresponding to text format requirements of a power generation party; and
means for outputting a text output file corresponding to the text format requirements of the power generation party based on the arrangement of the key identifiers.

14. The system of claim 13 wherein the power generation party is an Independent Systems Operators (ISO) group.
